(19) United States
(12) Patent Application Publication
(10) Pub. No.: US 2012/0168070 A1
(43) Pub. Date: Jul. 5, 2012

(54) LIGHT CONTROL FILM FORMATION

(75) Inventors: John C. NELSON, Sea Ranch, CA (US); Richard H. BOHNET, Sausalito, CA (US); Robert N. BLAIR, San Jose, CA (US)

(73) Assignee: SerraSolar, Inc., San Jose, CA (US)

(21) Appl. No.: 13/306,610

(22) Filed: Nov. 29, 2011

Related U.S. Application Data
(60) Provisional application No. 61/460,347, filed on Dec. 29, 2010.
(60) Provisional application No. 61/460,380, filed on Dec. 29, 2010.
(60) Provisional application No. 61/460,348, filed on Dec. 29, 2010.
(60) Provisional application No. 61/460,346, filed on Dec. 29, 2010.

(51) Int. Cl. B32B 37/12; B05D 5/02; B05D 3/02

(52) U.S. Cl. 156/280; 427/372.2; 427/387; 427/385.5; 427/383.1; 427/258

(57) ABSTRACT

Light control film formation methods are described herein where reflective louvers in small size scale (generally less than a few millimeters) may be formed between planar or nearly planar sheets. Regions of varying adhesion may be formed within the film such that when a filler material is planarized upon a base film and cured, the filler material may retract internally from regions having a relatively lower adhesion thereby forming gaps which function as reflective internal louvers.

### CROSS-REFERENCE TO RELATED APPLICATIONS

This application claims the benefit of priority to U.S. Prov. Pat. App. Ser. Nos. 61/460,346; 61/460,347; 61/460,348; and 61/460,380 each of which was filed Dec. 29, 2010 and each of which is incorporated herein by reference in its entirety.

### FIELD OF THE INVENTION

The present invention relates to methods and apparatus for controlling the formation of a light control film. More particularly, the present invention relates to methods and apparatus for controlling the formation of micro-louvres in thin films.

### BACKGROUND OF THE INVENTION

The term daylighting generally refers to applications in which incident daylight is allowed into buildings or other structures by diverting light from incident angles at which they would not otherwise provide useful light within the building or structure.

Exposed louver constructions are possible but are generally not desirable for daylighting due to difficulties in cleaning environmental contaminants that accumulate over time. Furthermore, films which are formed with internal micro-louvres may be difficult and relatively costly to manufacture at very small geometries.

Accordingly, there exists a need for methods and devices which are suitable for forming micro-louvres in thin films which are easy to clean and which are relatively cost effective.

### SUMMARY OF THE INVENTION

Constructions and manufacturing methods to create reflective louvers in small size scale (generally less than a few millimeters) that are embedded between planar or nearly planar sheets are described. Such methods may be used to form films and sheets for various application areas such as display privacy or general illumination.

One method of forming a film having one or more louvers formed internally may generally comprise providing a base film having a contoured profile with at least one sidewall, altering an adhesion of the at least one sidewall, planarizing the base film with a filler material, and curing the filler such that a portion of the filler retracts from the at least one sidewall and forms a gap internally within the film, wherein the gap forms a louver within the film.

Another variation for forming a film having one or more louvers formed internally may generally comprise providing a base film having a contoured profile with at least one cutting edge and at least one retaining surface, overlaying a louver film upon the base film such that the louver film is cut into at least one strip along the at least one cutting edge and adhered along the at least one retaining surface, projecting the strip of the louver film to extend away from the base film while remaining adhered to the at least one retaining surface, planarizing the base film and louver film with a filler material, and curing the filler such that a portion of the filler retracts from the strip of louver film and forms a gap internally within the film, wherein the gap forms a louver within the film.

Yet another variation is similar yet further comprises providing a base film having a contoured profile with at least one cutting edge, at least one retaining surface, and at least one sidewall. Rather than projecting the cut louver film away from the base film, the louver film may be contacted against at least one sidewall of the base film while remaining adhered to the at least one retaining surface. The base film and louver film may then be planarized with a filler material and then cured such that a portion of the filler retracts from the at least one sidewall and forms a gap internally within the film, wherein the gap forms a louver within the film.

### BRIEF DESCRIPTION OF THE DRAWINGS

FIG. 1A illustrates a side view of one variation of a base substrate film forming optically transparent bodies each projecting from a base and having at least two apposed faces with regions of relatively high and low adhesion separated by a cavity or valley.

FIG. 1B illustrates a side view of the base substrate film having a filler applied within the cavities and the subsequent formation of air gaps formed by the filler retracting from the faces to form internal louver regions.

FIG. 2A schematically illustrates an example of a thermoplastic material which may be directly extruded using a die to form a thin film sheet having a profile.

FIG. 2B illustrates a cross-sectional view of one example of a die profile.

FIGS. 3A and 3B illustrate another variation where a louver film may be placed on an optically transparent contoured base having regions for adhering to the film and adjacent regions for cutting the film.

FIG. 3C illustrates an example where a portion of the louver film which is cut may be biased or otherwise urged to project at an angle relative to the base substrate.

FIGS. 3D and 3E illustrate side views where the base substrate and projected louver film may be covered by a filler which forms internal louver regions.

FIGS. 4A and 4B illustrate side views of another variation where a louver film may be adhered along a portion of the optically transparent bodies when cut.

FIG. 4C illustrates a side view where the gap between the filler and optically transparent body may form an internal louver region.

### DETAILED DESCRIPTION OF THE INVENTION

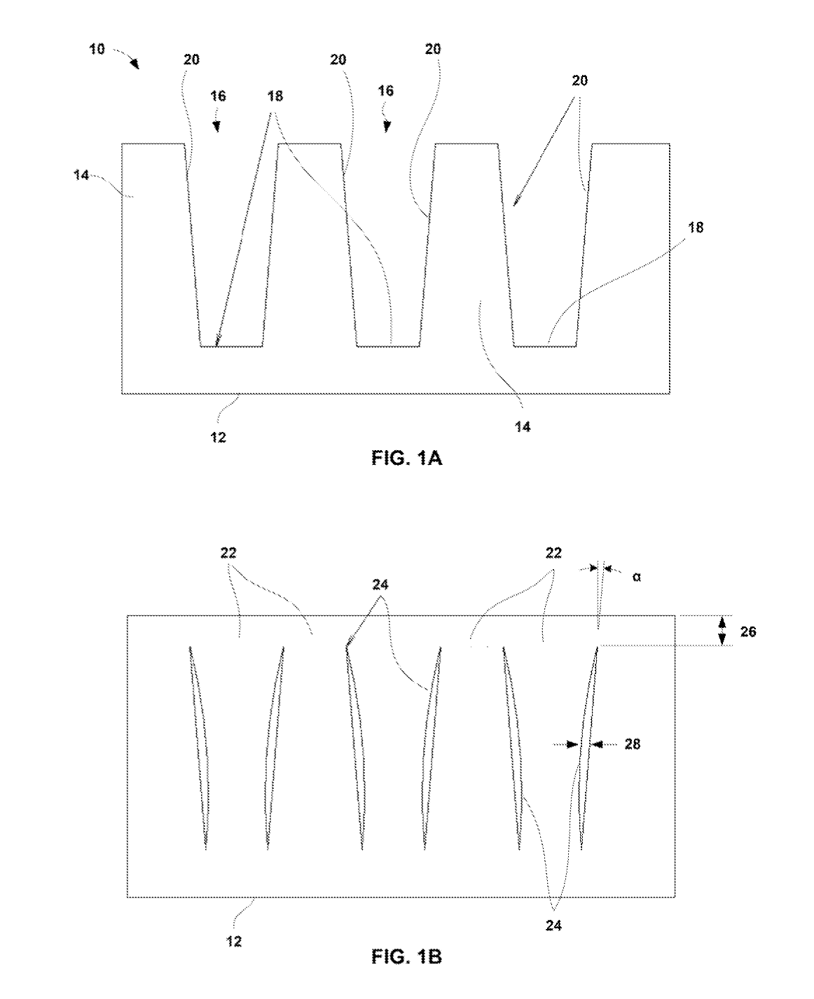

In forming micro-louvers internally within a film, a number of different methods and mechanisms may be utilized. One example is illustrated in the partial cross-sectional side view of FIG. 1A which utilizes regions of varying adhesion. The figure shows the side view of a film 10 having a relatively flattened base 12 with one or more optically transparent bodies 14 which project from the base 12 to form ridges or ribs extending over the film with channels or valleys 16 defined between adjacent bodies 14. The film 10 may have a thickness of just a few millimeters, e.g., from several millimeters such as about 2-3 millimeters to as small as tens of microns such as about 30 microns. Moreover, the optically transparent bodies 14 may define faces which are parallel to one another or angled at any number of angles relative to one another depending upon the desired angles of the louvers to be formed within the film 10. Examples of various constructions and configurations of films and transparent bodies may be further described in U.S. Pat. No. 6,616,285 which is incorporated herein by reference in its entirety.

Each of the faces or sidewalls 20 may be optically smooth and used to define the totally internally reflecting (“TIR”) louvers and thus may be formed to be parallel to one another or at various angles near normal relative to base 12. Alternatively, each of the sidewalls 20 may be angled relative to base 12 at predetermined angles, e.g., about 0 to about 25 degrees. Each of the sidewalls 20 may be uniformly angled relative to adjacent sidewalls 20 (e.g., each sidewall 20 may each be parallel to one another while being angled relative to base 12) or they may be alternated such that adjacent sidewalls 20 each have differing angles relative to one another. In yet other variations, the sidewalls 20 may be curved or arcuate depending upon the desired light reflection characteristics.

To create the TIR louvers, the shrinkage effects of the filler material and the material used to create the base 12 may be utilized. Generally, optically transparent thermoplastics, such as poly(methyl methacrylate) (“PMMA”) inherently experience bulk shrinkage upon solidification or curing. For example, PMMA has a bulk shrinkage factor of about 0.5% and up to several percent, e.g., 3% or more, while ultraviolet (“UV”) curable acrylates typically have bulk a shrinkage factor of a few percent. Moreover, the material properties of the base film 12 may be selected based upon the melt temperature and/or chemical compatibility during processing.

Taking advantage of the shrinkage factor, one or more of the sidewalls 20 may be formed with a surface having a relatively low adhesion relative to a higher adhesion of the bottom 18 of the channel or valley 16 and also relative to the top surfaces of the bodies 14. When the second filler polymer 22 (e.g., a viscous liquid during processing by virtue of elevated temperature or low level of cross-linkage) is filled and introduced into the channel or valley 16 and into contact against the bottom 18 and top surfaces of the bodies 14 to planarize and smooth the film, the surfaces of the sidewalls 20 may prevent adhesion of the filler 22 against the sidewalls 20 while the remaining exposed surfaces with their relatively higher adhesive surfaces may bond or strongly adhere with the filler material 22. The second filler polymer 22 may be the same or similar polymer used as the material of base 12 such that the regions of high adhesion may pin together (such as along the bottom 18 and top surfaces of bodies 14) immediately upon contact to form a uniform optically transparent material.

However, the filler 22 in contact along the sidewalls 20 may pull away from the weakly adhering regions as the filler 22 hardens and undergoes shrinkage. Resulting gaps 24 may thus be formed internally within the newly formed film where the sidewalls 20 and filler 22 formerly contacted against one another. These gaps 24 may thus form the micro-louvers having width which may range, e.g., on the order of a quarter of a wavelength of visible light such as on the order of 150 nanometers or up to several microns, as shown in FIG. 1B. Since the evanescent wave energy decays exponentially with gap width, gap widths above a quarter of a wavelength for visible light become effective for TIR. The newly formed micro-louvers may also be angled, u, depending upon the initial angle (if any) of the sidewalls 20 relative to the base 12. Moreover, the overall thickness of the newly formed film may be varied depending upon the amount of filler 22 material overlaid 26 upon the underlying base 12 and optically transparent bodies 14. The resulting film may be optically transparent while the formed gaps 24 function as louvers to achieve the UR effect with light transmitted through the film.

The regions of relative low and high adhesion may be created by various chemical coatings such as silicone or fluoropolymer release agents that may be a component of the polymer formulation. These coatings may be applied by a dip or spray coating to the base film 12 and the coating may be directionally applied or applied to all surfaces and selectively removed or inactivated at the top and bottom of the channels 16, e.g., by photo-activated chemical, plasma, corona or reactive ion etch process, etc.

Alternatively, the differing regions of adhesion may be formed by nano-replicated surface textures. Surface specific coatings can be applied to regions that only have different, molded in, surface topology on a micro or nanoscale. Generally the metal master tool may be masked and etched in selected regions and this surface texture may be transferred by the mold surface replication.

Another example for selectively creating regions of differing adhesion may include utilizing chemical reactions on replicated selected surfaces. As described above, replicated surface texture or surface treatment can radically change surface energy. For example, a clean and smooth PMMA surface is hydrophobic and has a water drop contact angle greater than ninety degrees resulting in water droplets beading up and rolling off the surface. If the PMMA is molded against an etched plate, such as a nano-grain electroplated hard copper material etched with a ferric or copper chloride solution, the replicated surface becomes hydrophilic. The wetting contact angle is reduced and water drops may wet the surface. Analogous to the above construction that begins with a base open channel film 12, the general differences in surface energy between the sidewalls 20 and optically clear areas between the sidewalls 20 can be used to for chemically surface selective reactions.

For daylighting louver films, chemical deposition of a highly reflective metal may be used. An example is silver deposited by an electroless reduction/oxidation reaction to create a durable silver coating on selected thermoplastic substrates. The catalyst (typically molecular mono-layers) for the surface reduction of silver on PMMA can be selectively applied only to the louver surfaces and/or removed (or inactivated) from the transparent film between louvers. After metal deposition on the sidewalls 20, the channels 16 may be then filled with the filler 22 to planarize the resulting film. Due to the varying adhesive properties, the filler 22 may pull away from the internal surfaces having the chemical coatings to form the internal louvers as described above.

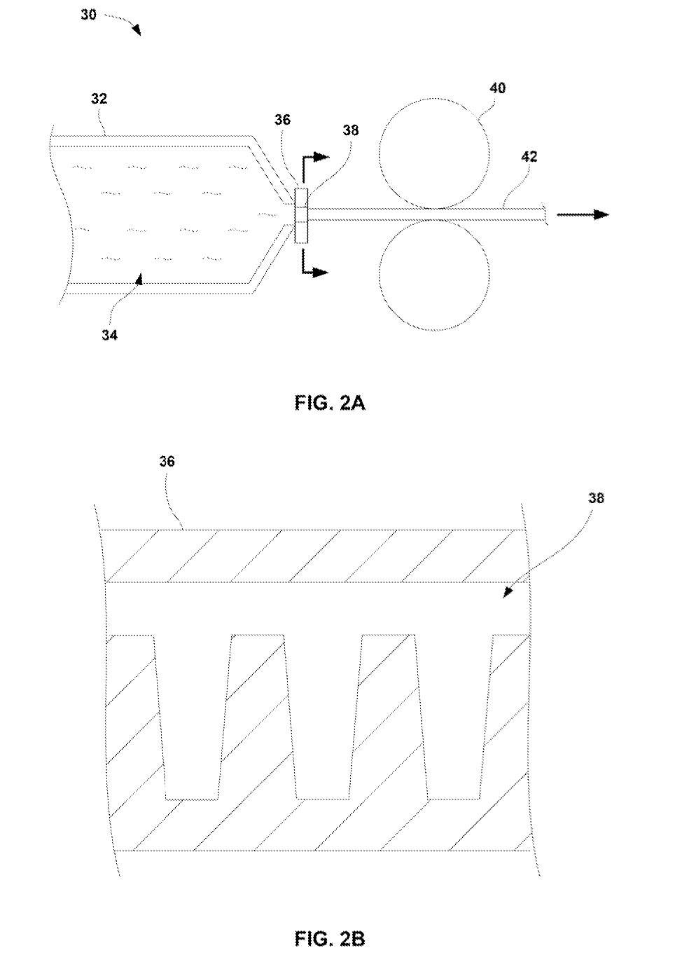

One mechanism for forming films having a particular profile such as that shown in base film 12 (for forming the micro-louvered films described herein) may utilize extrusion processes commonly used to form various materials having predetermined profiles, as shown in the illustration of FIG. 2A. An extrusion die 36 may be used to directly form a film 42 of a first polymer material containing a series of linear voids filled with either a gas or a second material such a mineral oil. An example of an extrusion die 36 having a predetermined contoured profile 38 may be seen in the cross-sectional view of FIG. 2B. Although the profile 38 is illustrated as having angled edges, various profiles may be utilized depending upon the desired profile and louver configurations to be formed in the resulting film. The extruded film 42 may be extruded from an extrusion assembly 30 having a reservoir 32 filled with a thermoplastic polymer 34 in liquid form. The polymer 34 may be extruded through the extrusion die 38 and pulled or guided via rollers 40 to form a film 42 having the desired contoured profile. This precursor film 42 can then be stretched, tentered, and/or calendered to shape and size the internal voids so that a functional light control film geometry may be ultimately formed.

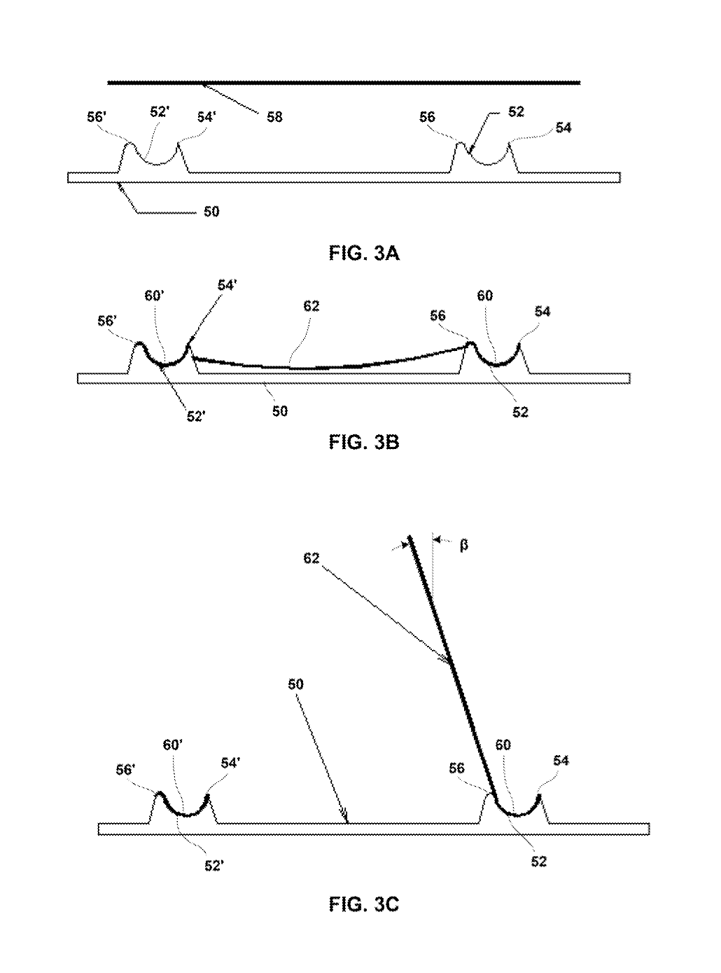

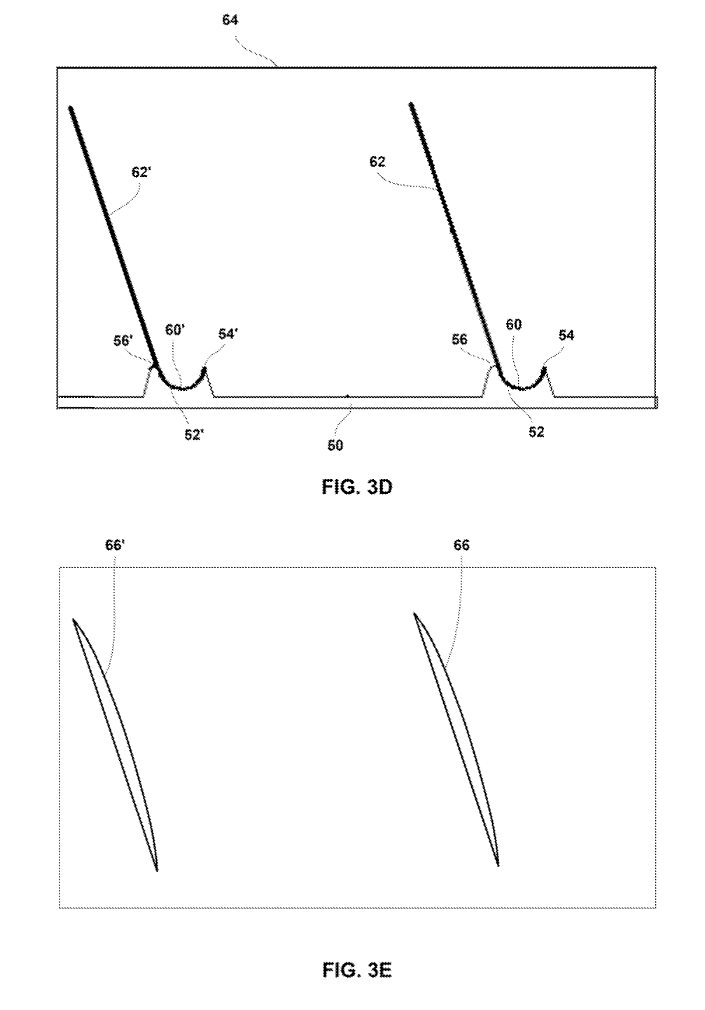

Another variation for forming TIR micro-louvered films is shown in the illustrations of FIGS. 3A to 3E which illustrate one example of self-forming louvers fabricated from a sheet material. A base film 50 may be formed to have one or more optically transparent bodies which project from the base 50 and extend along the film base 50, e.g., in parallel relative to one another. The one or more optically transparent bodies may each be formed to have a retaining surface 52, 52′ which may be formed to present a relatively smooth and atraumatic surface (such as a concave or convex surface forming a relatively large radius to form a pad for adhesion), a transitional surface 56, 56′ which may be curved or arcuate to present a surface over which a louver film may transition, and a cutting edge 54, 54′ (such as narrow vee-grooves) opposite to the transition surface 56, 56′, as illustrated in the side view of the profile of FIG. 3A.

The base louver film 50 may also optionally be an elastic material such as silicone or various rubber-like polymers. Alternatively, the base louver film 50 may alternatively be a shape memory film such as a shape memory polymer (e.g., polyethylene dispersion in a highly cross-linked silicone matrix) or a shape memory metal (e.g., Nitinol).

With the base film 50 laid flat, a louver film 58 may be overlaid upon the base film 50 such that the base film 50 is adhered along the optically transparent bodies over the retaining surfaces 52, 52′ and transitional surfaces 56, 56′. The louver film 58 may be formed of a sheet having a variety of different properties (e.g., optical, mechanical, rheological, surface, etc.) and functions as a precursor film that can be optically reflective or absorbing. Moreover, the louver film 58 is a relatively thin film so that it may be cut with cutting edges 54, 54′ and one that can be deformed yet recovers its nominally flat shape in areas where it is not mechanically constrained. Additionally, louver film 58 may be a composite, such as a polymer film coated with a material such as metal, metal oxide, etc. or coated with an ink or dye as a composite may allow for a combination of the desired optical and mechanical properties. Furthermore, the louver film 58 may also be optionally patterned with various images which may be visible at certain viewing angles and/or certain lighting conditions.

The louver film 58 may be pressed into contact against the base film 50, e.g., in a web process, to press the louver film 58 into contact against each of the respective surfaces and cutting edges. The portions 60 of the louver film 58 which are adhered along the retaining surfaces 52, 52′ may remain attached while the portions of louver film 58 which come into contact against the cutting edges 54, 54′ may be severed such that individual strips 62 of the louver film 58 are formed to extend from the retaining surface 52 and transitional surface 56 between adjacent optical bodies, as shown in FIG. 3B.

With the individual strips of the louver film 62 separated and temporarily trapped in the channels between each of the optically transparent bodies, the strips of louver film 62 may be treated to lift or angle the strip of material away from the base film 50 such that the strip of louver film 62 may pivot or flex over the transitional surfaces 56, 56′ to project away while the adhered portion 60 remains attached along the retaining surfaces 52, 52′, as shown in FIG. 3C. The strip of louver film 62 may project perpendicularly relative to the base film 50 or it may project at an angle as indicated by the angle, β, formed between the strip of louver film 62 relative to normal.

In order to project the strip of louver film 62, the base film 50 and louver film 62 may be thermally treated to restore any shape memory of the louver material, for example, heat treating the louver film 62 to a glass transition temperature, T_{g}, of thermoplastic component in the film material. In the case where the louver film 62 is comprised of an elastic material, louver extension may occur automatically once the material has been cut 10 upon the base film 50. In yet another variation, the louver surfaces may be treated to alter a surface energy and/or mechanical friction by applying a coating (e.g., silicone or fluorine coating) to enhance processing. Alternatively, the surfaces may be textured to create “anti-wetout” performance. In the case where TIR cavities or gaps are desired, the anti-wetout structures may prevent the intimate contact between the louver and another surface except in a very small fraction of the surface area, as described above.

The louver film material may also be coated and laminated with a low un-cured viscosity clear plastic material. The uncoated louvers may also become the basis for active changes in louver angles in response to mechanical; electrical, thermal, or other effects. As an example, the louver strip 62 may be angled to project by utilizing electrostatic modulation methods, for example, as described in U.S. Pat. No. 3,989,357 to Kalt, which is incorporated herein by reference in its entirety.

Once the louver strips 62, 62′ have been angled relative to base film 50, the base film and louver strips 62, 62′ may be coated with a filler material 64, as described above and as also shown in FIG. 3D. As the material is cured, shrinkage may occur between the louver strips 62, 62′ and the filler 64, particularly if the louver material has been treated to have a relatively lower adhesion (as previously described). The resulting cured film may thus form the TIR gaps 66, 66′, as shown in FIG. 3E, which function as internally formed louvers once when light is transmitted through the film.

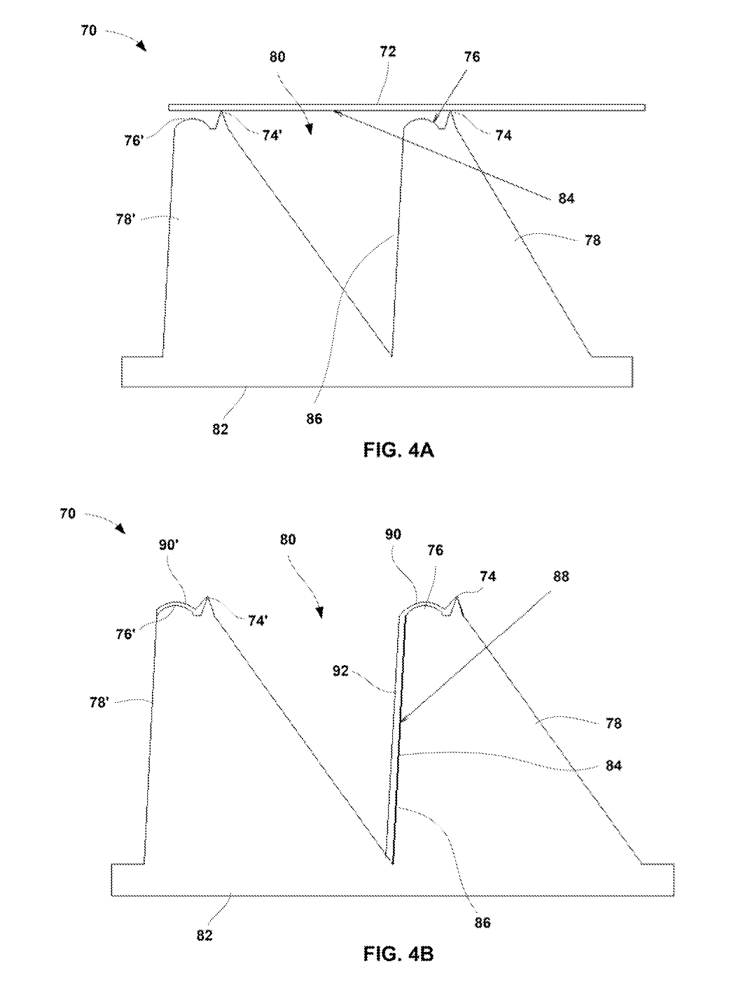

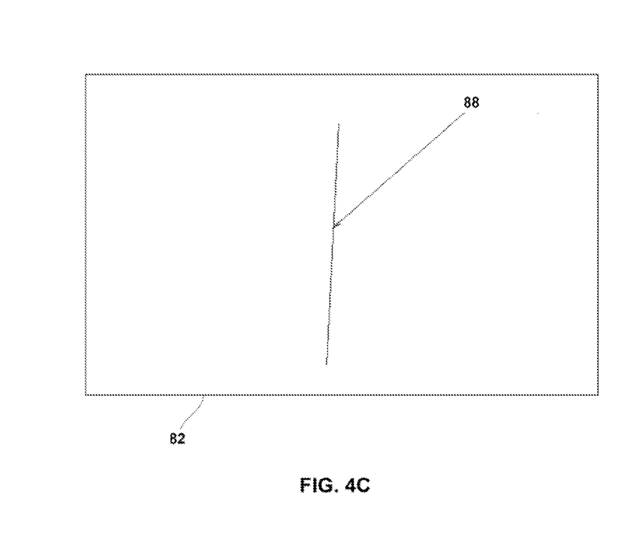

Another variation is illustrated in the side views of FIGS. 4A to 4C which show a film 70 having a base film 82 which one or more optically transparent bodies 78, 78′ forming relatively deeper channel structures 80. The transparent bodies 78, 78′ may be angled on a first side and may also form a sidewall 86 angled at any number of angles or curved concavely or convexly. The top of the transparent bodies 78, 78′ may similarly form culling edges 74, 74′ along with respective retaining surfaces 76, 76′. The louver film 72 may be overlaid atop the base film 82 and pressed down such that portions of the louver film 72 are cut along cutting edges 74, 74′ and portions 90 are adhered along retaining surfaces 76, 76′.

The reflective louver film 72 may include any of the films described above or it may also be a polymer multilayer film, e.g., Enhanced Specular Reflector Film (ESR, 3M, St. Paul, Minn.), a film with metal layers, and/or a film with anti-wetout structures along a surface of the film which contacts against the sidewall 86. The cut strips 84 of the louver film may fall into contact against the respective sidewall 86 which may be treated to alter its adhesion, as described above, or may also have a coating 88 to alter its adhesion properties, as shown in FIG. 4B. Additionally or alternatively, the louver film itself may have a coating 92 to alter its adhesion properties.

With the louver film strip 92 laid atop the base film 82, a tiller material (as previously described) may be introduced to planarize the surface. This forming may be done in one continuous coating operation that fills and laminates to a hardcoat or glass surface. Because of the adhesion differences, as the filler material cures, the one or more respective gaps 88 may be formed internally within the film to form the TIR louvers, as shown in FIG. 4C.

The applications of the devices and methods discussed above are not limited to films but such devices and methods may be applied to other applications. Modification of the above-described assemblies and methods for carrying out the invention, combinations between different variations as practicable, and variations of aspects of the invention that are obvious to those of skill in the art are intended to be within the scope of the claims.

What is claimed is:

1. A method of forming a film having one or more louvers formed internally, comprising:
providing a base film having a contoured profile with at least one sidewall;
altering an adhesion of the at least one sidewall;
planarizing the base film with a filler material; and,
curing the filler such that a portion of the filler retracts from the at least one sidewall and forms a gap internally within the film, wherein the gap forms a louver within the film.

2. The method of claim 1 wherein the base film comprises an optically transparent thermoplastic material.

3. The method of claim 1 wherein altering an adhesion comprises selectively coating the at least one sidewall.

4. The method of claim 3 wherein coating comprises coating with a chemical comprising silicone, fluoropolymer agent, or silver.

5. The method of claim 1 wherein altering an adhesion comprises forming a textured surface along the at least one sidewall to alter its surface energy.

6. The method of claim 1 wherein planarizing comprises introducing a thermoplastic filler material upon the base film.

7. The method of claim 1 wherein curing comprises forming the gap at a predetermined angle ranging from about 0 to about 25 degrees.

8. The method of claim 1 wherein curing comprises forming the gap to be normal relative to the base film.

9. The method of claim 1 wherein curing comprises forming the gap to be curved or arcuate.

10. The method of claim 1 wherein curing comprises forming the gap to have a width of about 150 nanometers to several microns.

11. The method of claim 1 wherein curing comprises retracting the filler from the at least one sidewall by about 0.5% to about 3%.

12. A method of forming a film having one or more louvers formed internally,
providing a base film having a contoured profile with at least one cutting edge and at least one retaining surface;
overlaying a louver film upon the base film such that the louver film is cut into at least one strip along the at least one cutting edge and adhered along the at least one retaining surface;
projecting the strip of the louver film to extend away from the base film while remaining adhered to the at least one retaining surface;
planarizing the base film and louver film with a filler material; and,
curing the filler such that a portion of the filler retracts from the strip of louver film and forms a gap internally within the film, wherein the gap forms a louver within the film.

13. The method of claim 12 wherein the base film comprises an optically transparent thermoplastic material.

14. The method of claim 12 further comprising altering an adhesion of at least one surface of the louver film.

15. The method of claim 14 wherein altering an adhesion comprises coating with a chemical comprising silicone, fluoropolymer agent, or silver.

16. The method of claim 14 wherein altering an adhesion comprises forming a textured surface along the at least one surface of the louver film to alter its surface energy.

17. The method of claim 12 wherein overlaying a louver film comprises pressing the louver film upon the base film.

18. The method of claim 12 wherein projecting the strip comprises thermally treating the louver film such that the strip extends away from the base film by shape memory.

19. The method of claim 12 wherein projecting the strip comprises electrostatically modulating the louver film such that the strip extends away from the base film.

20. The method of claim 12 wherein planarizing comprises introducing a thermoplastic filler material upon the base film.

21. The method of claim 12 wherein curing comprises forming the gap at a predetermined angle ranging from about 0 to about 25 degrees.

22. The method of claim 12 wherein curing comprises forming the gap to be normal relative to the base film.

23. The method of claim 12 wherein curing comprises forming the gap to be curved or arcuate.

24. The method of claim 12 wherein curing comprises forming the gap to have a width of about 150 nanometers to several microns.

25. The method of claim 12 wherein curing comprises retracting the filler from the strip by about 0.5% to about 3%.

26. A method of forming a film having one or more louvers formed internally,
providing a base film having a contoured profile with at least one cutting edge, at least one retaining surface, and at least one sidewall;
overlaying a louver film upon the base film such that the louver film is cut into at least one strip along the at least one cutting edge and adhered along the at least one retaining surface;
positioning the strip of the louver film to contact against the at least one sidewall while remaining adhered to the at least one retaining surface;
planarizing the base film and louver film with a filler material; and,
curing the filler such that a portion of the filler retracts from the at least one sidewall and forms a gap internally within the film, wherein the gap forms a louver within the film.

27. The method of claim 26 wherein the base film comprises an optically transparent thermoplastic material.

28. The method of claim 26 further comprising altering an adhesion of at least one surface of the louver film prior to positioning the strip.

29. The method of claim 28 wherein altering an adhesion comprises coating with a chemical comprising silicone, fluoropolymer agent, or silver.

30. The method of claim 28 wherein altering an adhesion comprises forming a textured surface along the at least one surface of the louver film to alter its surface energy.

31. The method of claim 26 wherein overlaying a louver film comprises pressing the louver film upon the base film.

32. The method of claim 26 wherein projecting the strip comprises thermally treating the louver film such that the strip extends away from the base film by shape memory.

33. The method of claim 26 further comprising altering an adhesion of at least one sidewall prior to positioning the strip.

34. The method of claim 26 wherein planarizing comprises introducing a thermoplastic filler material upon the base film.

35. The method of claim 26 wherein curing comprises forming the gap at a predetermined angle ranging from about 0 to about 25 degrees.

36. The method of claim 26 wherein curing comprises forming the gap to be normal relative to the base film.

37. The method of claim 26 wherein curing comprises forming the gap to be curved or arcuate.

38. The method of claim 26 wherein curing comprises forming the gap to have a width of about 150 nanometers to several microns.

39. The method of claim 26 wherein curing comprises retracting the filler from the strip by about 0.5% to about 3%.
